(19) United States
(12) Patent Application Publication
(10) Pub. No.: US 2008/0189580 A1
(43) Pub. Date: Aug. 7, 2008

(54) Automated Testing Device and Method of Data Broadcasting Receivers Based on Test Scenario

(75) Inventors: Youngwha Kim, Gyeonggi-do (KR); Jinyoung Yang, Gyeonggi-do (KR); Wonchun Lee, Gyeonggi-do (KR); Eunhyang Lee, Gyeonggi-do (KR); Dongyoung Park, Gyeonggi-do (KR); Heesun Kim, Gyeonggi-do (KR); Keunku Lee, Gyeonggi-do (KR)

Correspondence Address: LAHIVE & COCKFIELD, LLP, ONE POST OFFICE SQUARE, BOSTON, MA, 02109, US

(73) Assignee: Teleommunications Technology Association Techno, Seongnam-Si (KR)

(21) Appl. No.: 11/884,634

(22) PCT Filed: Aug. 18, 2005
(86) PCT No.: PCT/KR05/02712

§ 371 Date: Aug. 17, 2007

(30) Foreign Application Priority Data
Feb. 26, 2005 (KR) 10-2005-0016201

(51) Int. Cl. H04L 12/26

(52) U.S. Cl. 714/712

(57) ABSTRACT

Disclosed are a method and an apparatus for automatically testing a data broadcast receiver, so that a sub-system can be constructed with an independent module and a distributed processing can be easy to achieve, in which both an interface between sub-systems and an interface between a test manager and a sub-system are connected by a packet communication scheme using a universalized TCP/IP, test results are collected by means of an uplink return channel of bi-directional channels in an out-of-band channel hold by a broadcasting receiver, a module for generating information on the out-of-band channel is integrally constructed within one test device, a graphic user interface is applied in the Windows environment of the Microsoft corporation, and a scenario including storage of remocon operation and screen state is automatically processed. In the method and the apparatus, in a state in which the middleware of a complicated data broadcast receiver has been implemented, personnel expenses can be reduced and test results can be systematically derived.

### TECHNICAL FIELD

The present invention relates to an automated testing device and testing method for a broadcasting receiver, in which, when a broadcasting receiver (test-targeted device) is subjected to tests by means of a scenario-based automated testing device, test data are automatically transmitted to the test-targeted device based on a scenario set by a manager, test result values outputted from the test-targeted device are stored, and the stored test result values are analyzed and reported. More particularly, the present invention relates to a method and an apparatus for automatically testing a data broadcast receiver, so that a sub-system can be constructed with an independent module and a distributed processing can be easy to achieve, in which both an interface between sub-systems and an interface between a test manager and a sub-system are connected by a packet communication scheme using a universalized TCP/IP, test results are collected by means of an uplink return channel of bi-directional channels in an out-of-band channel held by a broadcasting receiver, a module for generating information on the out-of-band channel is integrally constructed within one test device, a graphic user interface is applied in the Windows environment of the Microsoft corporation, and a scenario including storage of remote control (hereinafter, referred to as remocon) operation and screen state is automatically processed.

### BACKGROUND ART

In order to check an implementation state of interfaces and platforms (hereinafter, referred to as middleware) for application programs of a data broadcast receiver, a great number of test applications constituting one set are transmitted to a receiver, and a response of the receiver regarding each test application is observed. Therefore, it is possible to check the implementation state of the receiver middleware. Since thousands of test applications exist, much time and effort are required to manually operate the numerous test applications.

Among the conventional scenario-based automated testing systems, there is a Multimedia Home Platform Automatic Test Environment (MHP ATE), which is provided by Unisoft, Inc. in Europe as an automated testing system for a European-type data broadcast receiver. Further, CableLabs, Inc. in USA has been developing an OpenCable Application Platform Automatic Test Environment (OCAP ATE) based on the MHP ATE.

The prior arts include a test manager for managing tests based on an input test scenario, a transmission manager for transmitting test applications, an interactor for communicating with a test-targeted device and collecting test results, a media storage unit, and a reset and remocon controller. The media storage unit provides a tester with information on the basis and the time of determination for both video and audio outputted from the test-targeted device so that the tester can directly check the video and the audio and determine test results, and awaits and receives a response from the tester. The reset and remocon controller initializes the test-targeted device, informs the tester of the time and the method of a remocon operation when a test control by way of the remocon is necessary, controls the power of an input sub-system and a receiver, and performs an initialization of the test-targeted device. The input sub-system induces an operation of the remocon control signals from the manager.

However, since a scheme for interface between the test manager and each sub-system is a library type provided from the sub-system, the sub-system is connected by using a software module provided by a specific library within one physical unit system. Therefore, it is difficult to divide the sub-system into separate units and an expansion of the sub-system is not easy to achieve.

As for a method for collecting test results, the test-targeted device is connected to the interactor through a serial port or a TCP/IP port. When the remocon is operated or a screen display state is checked, test is performed at the tester's approval. Therefore, the test applications are automatically transmitted under the scenario, while a manual operation to be performed by the tester is a necessary component of the test process.

Further, apparatuses for generating and transferring out-of-band signals, which are required for a digital cable broadcasting system in North America and Korea, are not consolidated within one test device. For this reason, separate external matching device is necessary. Furthermore, since a user interface is provided by a Linux-based character screen scheme in operation environments of the conventional apparatus, there are significant limitations both in visualizing and in providing a test construction and a progress status.

### DISCLOSURE OF THE INVENTION

Therefore, the present invention has been made in view of the above-mentioned problems, and it is an object of the present invention to provide a method and an apparatus for automatically testing a data broadcast receiver, so that a sub-system can be constructed with an independent module and a distributed processing can be easy to achieve, in which both an interface between sub-systems and an interface between a test manager and a sub-system are connected by a packet communication scheme using a universalized TCP/IP, test results are collected by means of an uplink return channel of bi-directional channels in an out-of-band channel hold by a broadcasting receiver, a module for generating information on the out-of-band channel is integrally constructed within one test device, a graphic user interface is applied in the Windows environment of the Microsoft corporation, a scenario including storage of remote control operation and screen state is automatically processed.

According to one aspect of the present invention, there is provided an automated testing method for a data broadcast receiver based on a test application, various channel configuration information according to the test application, and scenario information, the method including the steps of: (a) the test application setting a test scenario according to a test application program and a test sequence which are suitable for a test-targeted device; (b) a test manager checking a communication connection between the test manager and a sub-system in order to ensure physical communication channels with the sub-system, initializing internal hardware, internal state information and communication matching of the sub-system when the communication connection is checked, and performing an initialization for the test-targeted device; (c) a transmission manager forming a transport stream, and transmitting the transport stream the test-targeted device by a command from the test manager, starting a return time count in order to receive test result values from a time point at which an interactor has transferred downloading confirmation signals of the transport stream to the test manager; (d) when it is necessary to input remocon signals to the test-targeted device, a reset and remocon controller transmitting IR signals suitable for the test-targeted device; (e) when it is necessary to reset the test-targeted device, initializing the test-targeted device; (f) when it is necessary to stop a test momentarily, an automated testing device stopping the test; (g) When the test starts according to test types and the test result values are not transmitted to the test manager even after return time lapses, the test manager commanding the transmission manager to stop the transport stream, and terminating the test; (h) when the test is normally terminated, transmitting the test result values to the test manager through the interactor, and reporting the termination of the test; (i) when the test result values correspond to video displayed on a screen or audio, the media storage unit storing the test result values; (j) when the interactor notifies the test manager of the termination of the test, or when the media storage unit completes the storage of the video or the audio, determining whether residual tests exist in the scenario; and (k) when the residual tests exist in the scenario, the test manager commanding an initialization of the sub-system, initializing the test-targeted device after the sub-system is initialized, and reopening the residual tests.

According to another aspect of the present invention, there is provided an automated testing system for a data broadcast receiver based on a test application, various channel configuration information according to the test application, and scenario information, the system including: a test manager for transmitting signals to a sub-system, receiving signals returned from the sub-system, controlling an entire flow of a test process, and managing test results; a transmission manager for processing application programs and channel configuration information, which are received through the test application, like actual broadcasting environments; an interactor for checking download of the test application to a test-targeted device, and transferring information to the test-targeted device during a test; a media storage unit for storing video on screen or audio output results of test result values; a reset and remocon controller for initializing the test-targeted device and generating remocon control signals; a report manager for processing the test result values in a report form and outputting various reports; a results database for storing the test result values; and a combiner/divider for combining RF signals transmitted from a modulator and an out-of-band channel transceiver into one RF signals, and inputting the combined RF signals to the test-targeted device.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a block diagram illustrating a scheme for constructing test environments of an automated testing device for a broadcasting receiver based on a scenario according to an embodiment of the present invention;

FIG. 2 is a block diagram illustrating the construction of an automated testing device for a data broadcast receiver based on a scenario according to an embodiment of the present invention;

FIG. 3 is a block diagram illustrating the construction of a transmission manager in an automated testing device for a data broadcast receiver based on a scenario according to the present invention;

FIG. 4 is a block diagram illustrating the construction of a main control manager in an automated testing device for a data broadcast receiver based on a scenario according to the present invention;

FIG. 5 is a block diagram illustrating the construction of an interactor in an automated testing device for a data broadcast receiver based on a scenario according to the present invention;

FIG. 6 is a block diagram illustrating the constructions of a report manager and a results database in an automated testing device for a data broadcast receiver based on a scenario according to the present invention;

FIG. 7 is a block diagram illustrating the construction of a media storage unit in an automated testing device for a data broadcast receiver based on a scenario according to the present invention;

FIG. 8 is a block diagram illustrating the construction of a reset and remocon controller in an automated testing device for a data broadcast receiver based on a scenario according to the present invention; and

FIG. 9 is a flow diagram illustrating a method for testing a common platform of a broadcasting receiver by using an automated testing device for a data broadcast receiver based on a scenario according to the present invention.

### BEST MODE FOR CARRYING OUT THE INVENTION

Reference will now be made in detail to the preferred embodiment of the present invention. The same reference numerals are used to designate the same elements as those shown in other drawings. In the following description of the present invention, a detailed description of known configurations and functions incorporated herein will be omitted when it may make the subject matter of the present invention rather unclear.

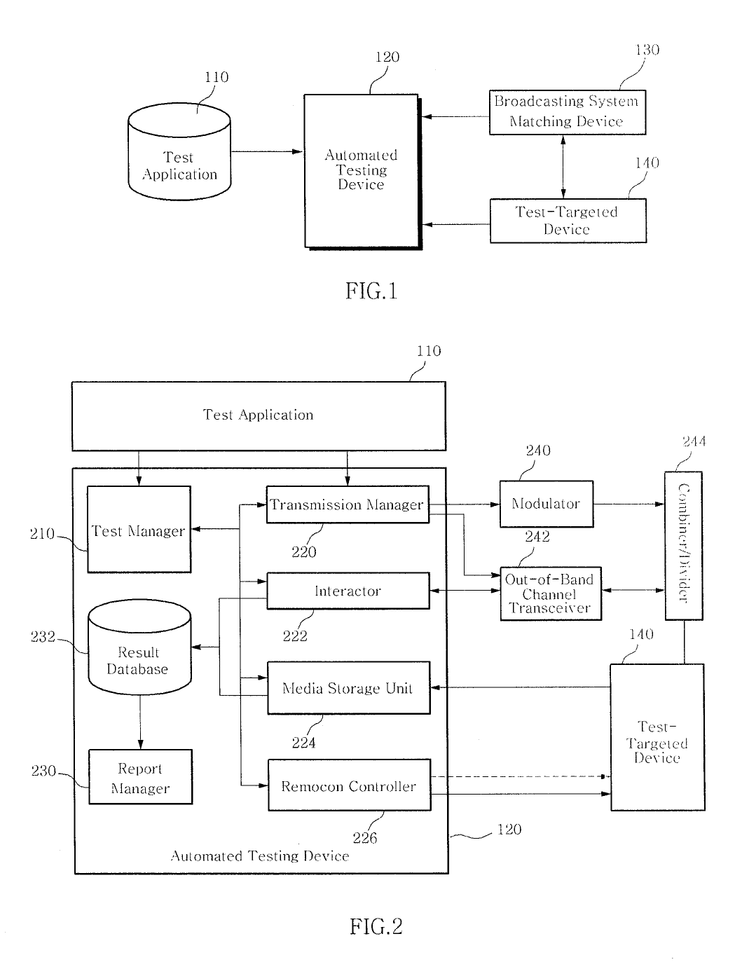

FIG. 1 is a block diagram schematically illustrating an automated testing system for a broadcasting receiver according to a preferred embodiment of the present invention.

The automated testing system for the broadcasting receiver according to the present invention includes a test application 110, an automated testing device 120, a broadcasting system matching device 130, and a test-targeted device 140.

The test application 110 includes a test scenario which is a combination of test application programs used for various tests.

The automated testing device 120 automatically transmits test application programs to the test-targeted device 140 according to a scenario transmitted from the test application 110, collects a response from the test-targeted device 140, and outputs test results.

The broadcasting system matching device 130 converts signals between the automated testing device 120 and the test-targeted device 140, and outputs the converted signals.

The test-targeted device 140 represents a data broadcast receiver which may be used for a digital cable broadcasting system or terrestrial broadcasting in North America and Korea.

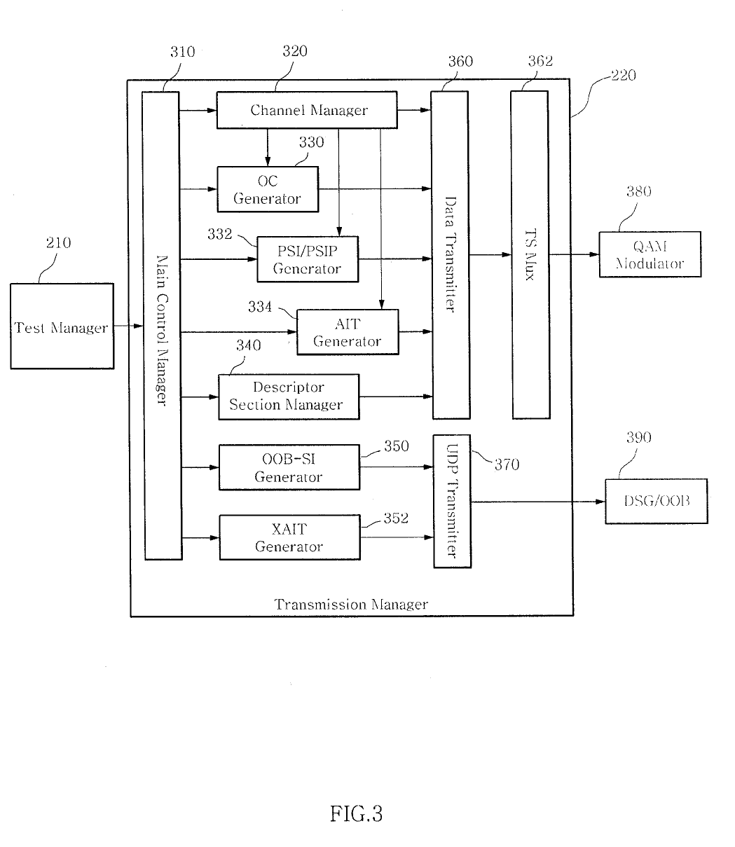

FIG. 2 is a block diagram illustrating the construction of an automated testing device for a data broadcast receiver based on a scenario according to an embodiment of the present invention.

The automated testing device 120 receives a preset scenario, tests the test-targeted device 140, and automatically receives and stores test result values. The automated testing device 120 includes a sub-system having a test manager 210, a transmission manager 220, an interactor 222, a media storage unit 224, a reset and remote control (hereinafter, referred to as remocon) controller 226, a report manager 230, a results database 232, etc.

When the automated testing device 120 starts to test the test-targeted device 140, the test manager 210 sends signals to the sub-system, and receives returned signals, thereby controlling the entire flow of the test process and managing test results.

The transmission manager 220 processes application programs and channel configuration information, which are received through the test application 110, like actual broadcasting environments, converts in-band signals to Radio Frequency (hereinafter, referred to as RF) signals through a modulation process of a modulator 240, and transfers out-of-band system information and program information, etc., to a combiner/divider 244 as RF channel signals through an out-of-band channel transceiver 242.

The interactor 222 checks if a Transport Stream (hereinafter, referred to as TS) has been normally downloaded to the test-targeted device 140, and transfers information to the test-targeted device 140 during the test.

The media storage unit 224 stores video on screen or audio output results of test results in a specific directory selected in an environment setup menu by the automated testing device 120.

The reset and remocon controller 226 generates remocon control signals when it is necessary to initialize the test-targeted device 140 after one test unit for the test-targeted device 140 ends, or when it is necessary to operate a remocon during the test.

The report manager 230 processes the test results in a report form when the test by the TS ends for the test-targeted device 140, and outputs various reports.

The results database 232 compiles the test result values into a database when the test ends, and stores the database.

The combiner/divider 244 combines two RF signals transmitted from both the modulator 240 and the out-of-band channel transceiver 242 into one RF signal, and transmits the combined RF signal to the test-targeted device 140.

Since the construction and management of a database required for the present invention are apparent to those skilled in the art, a detailed description will be described.

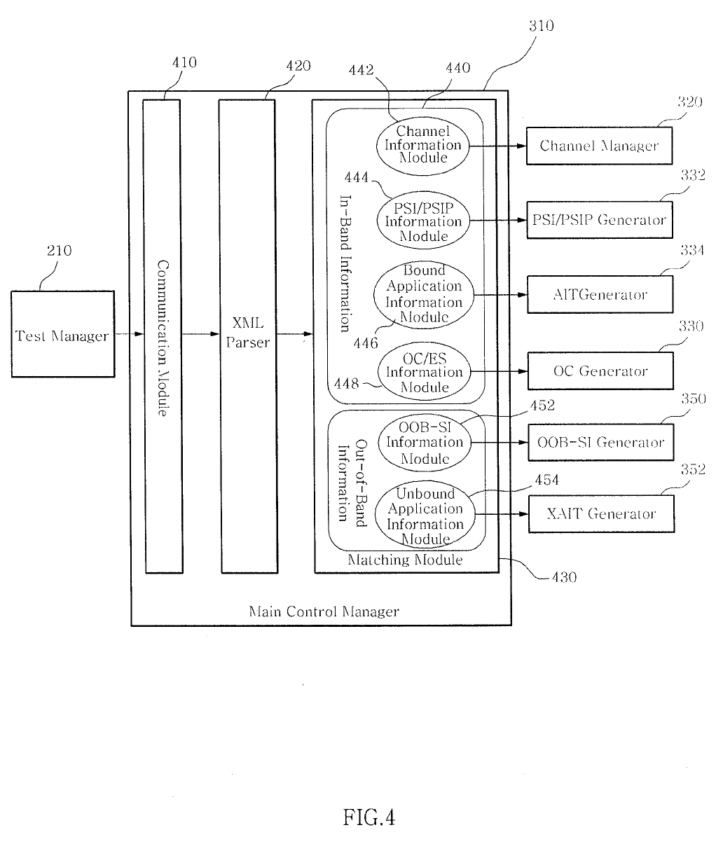

FIG. 3 is a block diagram illustrating the construction of the transmission manager 220 in the automated testing device for the data broadcast receiver based on the scenario according to the present invention.

The transmission manager 220 corresponds to a sub-system for processing the application programs and channel configuration information, which are received through the test application 110, like actual broadcasting environments. The transmission manager 220 includes a main control manager 310, a channel manager 320, an Object Carousel (hereinafter, referred to as OC) generator 330, a Program Specific Information/Program System Information Protocol (hereinafter, referred to as PSI/PSIP) generator 332, an Application Information Table (hereinafter, referred to as AIT) generator 334, a descriptor section manager 340, an Out-Of-Band-System Information (hereinafter, referred to as OOB-SI) generator 350, an eXtended Application Information Table (hereinafter, referred to as XAIT) generator 352, a data transmitter 360, a TS mux 362, a User Datagram Protocol (hereinafter, referred to as UDP)transmitter 370, a Quadrature Amplitude Modulation (hereinafter, referred to as QAM) modulator 380, a DOCSIS Settop Gateway/Out-Of-Band (hereinafter, referred to as DSG/OOB) 390, etc.

The main control manager 310 communicates with the test manager 210, and analyzes a TS description file received from the test application 110, thereby extracting information necessary for generating an OC, information necessary for generating a PSIP, information necessary for generating an AIT, information necessary for managing channels, information necessary for generating an OOB-SI and an XAIT, etc.

The channel manager 320 classifies channel information extracted by and transmitted from the main control manager 310 into a main channel and a sub-channel for management.

The OC generator 330 generates an OC based on a Digital Storage Media-Control Commands (hereinafter, referred to as DSM-CC) international standard.

The PSI/PSIP generator 332 generates various tables from program and system information based on digital broadcasting-related standards.

The AIT generator 334 generates an application information table.

The descriptor section manager 340 manages descriptors used by the tables that are generated by the OC generator 330, the PSI/PSIP generator 332, and the AIT generator 334.

The OOB-SI generator 350 generates the program and system information necessary for transmitting an unbound application.

The XAIT generator 352 generates unbound application information.

The data transmitter 360 codes not only test audio and video signals but also the generated tables of the OC, the AIT and the PSI/PSIP into TSs in order to transmit RF signals, and periodically transmits the TSs. The TS mux 362 multiplexes all generated TSs, thereby forming one RF signal

The UDP transmitter 370 transmits the OOB-SI and the XAIT to the DSG/OOB 390.

An operation in which the transmission manager 220 transmits one test application 110 is differently performed in the case of a bound application connected with a broadcasting service and in the case of an unbound application which is not connected with a broadcasting service.

In the case of the bound application, the main control manager 310 having received the TS description file from the test manager 210 extracts and stores information necessary for generating an AIT, information necessary for generating program and system information about audio and video streams, an AIT and an OC, information necessary for generating an OC for data, and information necessary for managing physical and logical channel information. The AIT generator 334 generates an AIT including information for a test application and signaling information regarding an execution of the test application. The OC generator 330 generates an OC for a test application, and the PSI/PSIP generator 332 generates various tables representing program and system information. Herein, descriptors necessary for the tables are managed by the descriptor section manager 340. The tables and test application elements generated as described above are coded into TSs by the data transmitter 360 according to corresponding channels, and are transmitted as RF signals through the TS mux 362.

In the case of the unbound application, the main control manager 310 having received the TS description file from the test manager 210 extracts and stores information necessary for out-of-band transmission, such as information necessary for generating an XAIT including information for the unbound application, signaling information, etc., and information necessary for generating program and system information for an XAIT and a test application. The XAIT generator 352 generates an XAIT for a test application by using the extracted information, and the OOB-SI generator 350 generates various tables representing program and system information for a test application and an XAIT. All tables and test application elements generated as described above are transmitted to the DSG/OOB 390 through UDP/IP multicast via the UDP transmitter 370.

FIG. 4 is a block diagram illustrating the construction of the main control manager 310 in the automated testing device for the data broadcast receiver based on the scenario according to the present invention.

The main control manager 310 includes a communication module 410 for communicating with the test manager 210, an eXtensible Markup Language (hereinafter, referred to as XML) parser 420 for extracting various information, etc., for forming a channel from an XML file, a matching module 430 for generating in-band and out-of-band signals, etc.

The XML parser 420 extracts various channel configuration information stipulated in broadcasting standard technology in North America and Korea, such as AIT information, OC information, PSI/PSIP information, and OOB-SI information for construction of a TS. The channel configuration information extracted by the XML parser 420 includes in-band information 440 and out-of-band information 450.

The in-band information 440 includes a channel information module 442, a PSI/PSIP information module 444, a bound application information module 446, and an OC/ES information module 448.

The channel information module 442 generates information necessary for managing a data service for a transmission channel, and sends the generated information to the channel manager 320. That is, the channel manager 320 generates various control messages, such as application start and end information messages, OC update messages and stream event triggering messages, according to channels, controls channels based on the received information, and monitors in realtime operation information of the transmission manager 220.

The PSI/PSIP information module 444 generates the various channel information included in one physical frequency (generally, a TS), i.e. system information, program information such as AV stream information for each channel, and Electronic Program Guide (hereinafter, referred to as EPG) information (supplementary information), and transfers the generated information to the PSI/PSIP generator 332.

The PSI/PSIP information module 444 is extracted by the XML parser 420, and is different according to test-targeted devices. In the case of a terrestrial digital broadcasting receiver, the PSI/PSIP information module 444 generates channel and service information required for Advanced Television Systems Committee (ATSC) and Advanced Common Application Platform (ACAP) standard schemes (technology standards in North America and Korea). In the case of a cable broadcasting receiver, the PSI/PSIP information module 444 generates information required for open cable and Opencable Common Application Platform (OCAP) standard schemes (technology standards in North America and Korea). In the case of a satellite receiver, the PSI/PSIP information module 444 generates channel configuration and service information required for a Digital Video Broadcasting-Multimedia Home Platform (DVB-MHP) adopted in Korea.

The bound application information module 446 generates information regarding broadcasting applications. For example, the bound application information 446 generates signaling information and binding information of an application under transmission, and provides the generated information to the AIT generator 334. The AIT generator 334 uses both the information, which is included in a message received as application start information from the main control manager 310, and parameter values generated in OC encoding, as data necessary for generating an AIT, and generates an AIT table necessary for application signaling based on the data.

The OC/ES information module 448 generates the various information used when the OC generator 330 applies the DSM-CC international standard and forms an OC for a test application. The OC generator 330 modularizes an object message, such as a file message to be transmitted to a channel, a directory message, a service gateway message and a stream event message, based on both the various information used for forming the OC and management information received from the channel manager 320, and transmits the object message and the modularized message in carousel form.

The out-of-band information 450 includes OOB-SI information module 452 and unbound application information module 454.

The OOB-SI information module 452 generates out-of-band channel information stipulated in technical standards in North America and Korea, transmits the generated out-of-band channel information to the OOB-SI generator 350. The OOB-SI generator 350 provides information for total service channels, EPG data, service access control information for pay channels based on the received information, and provides various types of table information according to broadcasting service profiles.

The unbound application information module 454 provides information for generating an XAIT recommended in the digital cable broadcasting standards in North America and Korea, includes signaling information for unbound application programs independent on a specific service, etc., and transmits the signaling information to the XAIT generator 352.

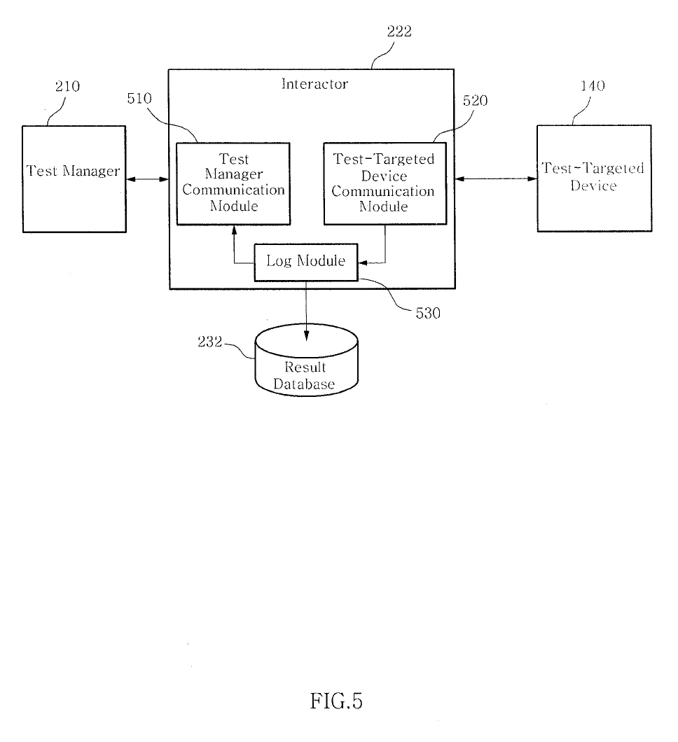

FIG. 5 is a block diagram illustrating the construction of the interactor 222 in the automated testing device for the data broadcast receiver based on the scenario according to the present invention.

The interactor 222 checks if the test application 110 has been normally downloaded to the test-targeted device 140, and transfers information to the test-targeted device 140 during the test. The interactor 222 includes a test manager communication module 510, a test-targeted device communication module 520, a log module 530, etc.

The interactor 222 transmits information for logs, prompts, test result values, etc., received from the test-targeted device 140, to the log module 530 through the test-targeted device communication module 520. The log module 530 stores the received information in the results database 232, and transmits the corresponding contents to the test manager 210 through the test manager communication module 510.

Further, the interactor 222 manages log and extra information, etc., received from each test-targeted device 140, by means of identifiers of multiple test-targeted devices 140, thereby supporting the tests for the test-targeted devices 140.

The test-targeted device communication module 520 transmits execution logs, test results, prompt-related information, etc., to the interactor 222 through a TCP/IP, which are created by using a Java method including logs of org, dvb, test and DVBTest, prompts, terminates, etc., used in the test-targeted device 140. Herein, when the test-targeted device communication module 520 transmits the information through a return channel of an out-of-band channel according to the construction of the test-targeted device 140, the test-targeted device communication module 520 receives result values from a return channel server through the TCP/IP, and transmits the received result values to the interactor 222.

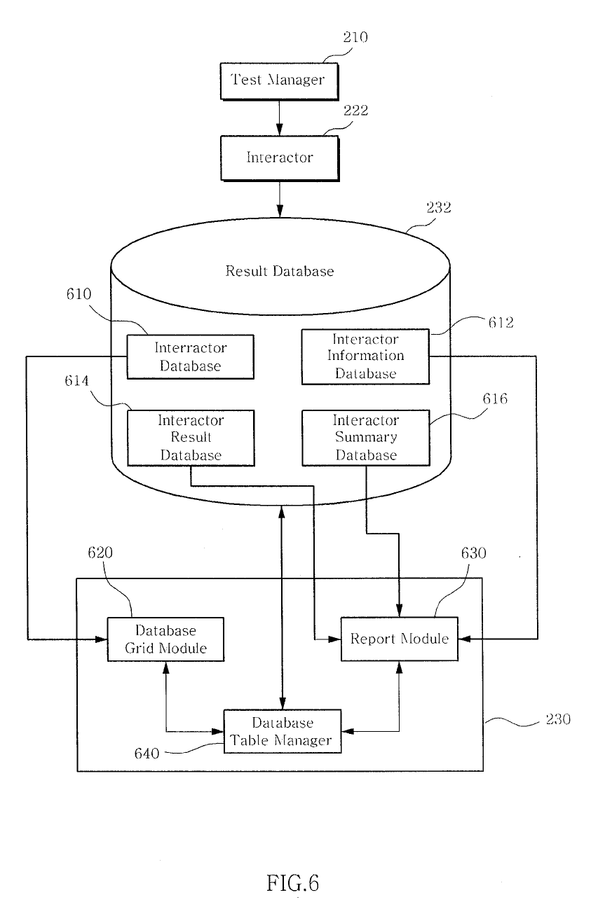

FIG. 6 is a block diagram illustrating the constructions of the report manager 230 and the results database 232 in the automated testing device for the data broadcast receiver based on the scenario according to the present invention.

The results database 232 represents a database used for efficiently storing, managing and displaying test logs, which are based on a MicroSoft Structured Query Language (MS SQL). The results database 232 includes four database tables, i.e. an interactor database 610, an interactor information database 612, an interactor results database 614 and an interactor summary database 616. Whenever the test manager 210 starts a test, tables are generated according to test names. Accordingly, a manager can load the executed test log from the results database 232, and confirm the test log. Further, the manager can confirm the test result values through various types of reports, store the test result values in a HyperText Markup Language (HTML) form, a Quality Resource Planning (QRP) form, etc., and transfer the stored test result values through E-mail.

Hereinafter, a process for generating the results database 232 will be described. First, the test manager 210 starts tests and simultaneously stores test names in a registry. Then, the interactor 222 reads the stored test names from the registry, and generates four database tables which have corresponding test names, respectively. If the interactor 222 succeeds in generating the databases, the interactor 222 stores test-related information, i.e. system information, an ATE version, test performance time, configuration information of each test, etc., in the interactor information database 612. If ? is generated during the tests, the interactor 222 immediately stores the generated ? in the interactor database 610. Further, whenever each test set ends, the interactor 222 synthesizes results, error messages and test time, and stores the synthesized content in the interactor results database 614. If all tests end according to the scenario, the interactor 222 arranges result values according to test regions (davic, dvb, havi and ocap), and stores the arranged result values in the interactor summary database 616.

The report manager 230 represents a functional module for informing a manager of the synthesized test results, which is based on the material stored in the results database 232, in the last step of the tests. The report manager 230 includes a database grid module 620, a database table manager 640 for managing total database tables, a report module 630, etc. The database grid module 620 displays test logs stored in the database selected by the manger through a main screen, thereby allowing the manager to search for the test logs. The report module 630 collects the OCAP middleware test results in a form desired by the manager, and displays the collected test results to the manager or stores the collected test results in a document.

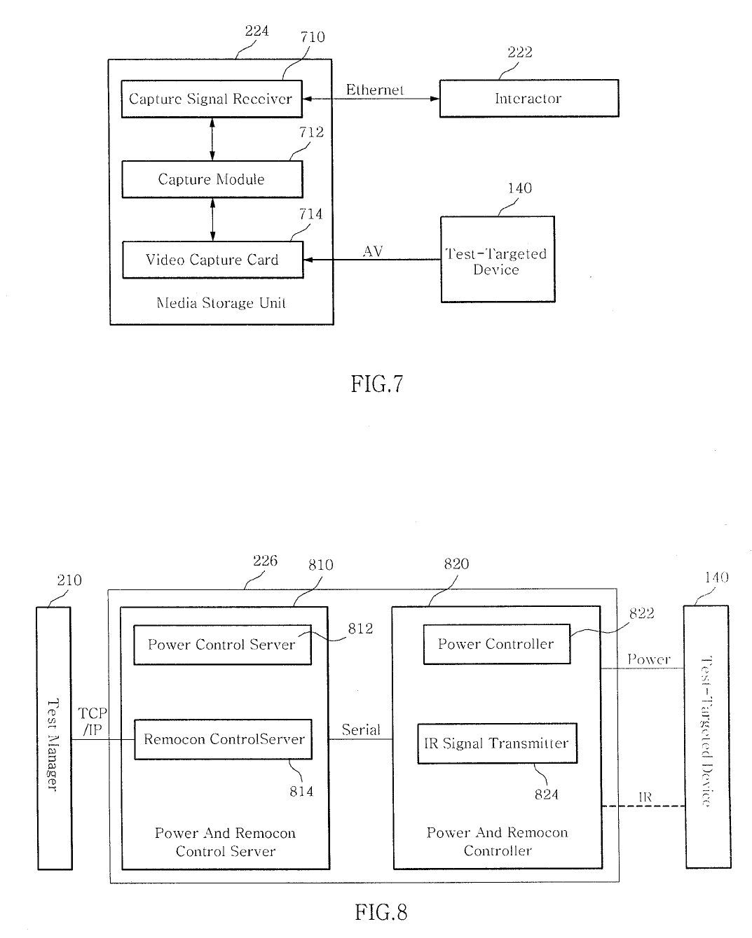

FIG. 7 is a block diagram illustrating the construction of the media storage unit 224 in the automated testing device for the data broadcast receiver based on the scenario according to the present invention.

When it is necessary to store video on screen or audio output results of the test result values, the media storage unit 224 performs a capture operation by the command from the interactor 222. The media storage unit 224 includes a capture signal receiver 710, a capture module 712, a video capture card 714, etc.

The capture signal receiver 710 receives capture signals by communicating with the interactor 222, and the capture module 712 transmits predetermined commands to the video capture card 714, which include capture start and end commands, selection commands of types of images to be stored and video input terminals, etc. The video capture card 714 stores the screen, which is displayed as output of the test-targeted device 140, in a composite type, or stores the current image on an S-video terminal as a dynamic image, an image file of a BMP, an JPG, etc., or an audio file. The information stored as described above is transferred to the interactor 222 through the capture signal receiver 710, and is used as media capture information for a corresponding test.

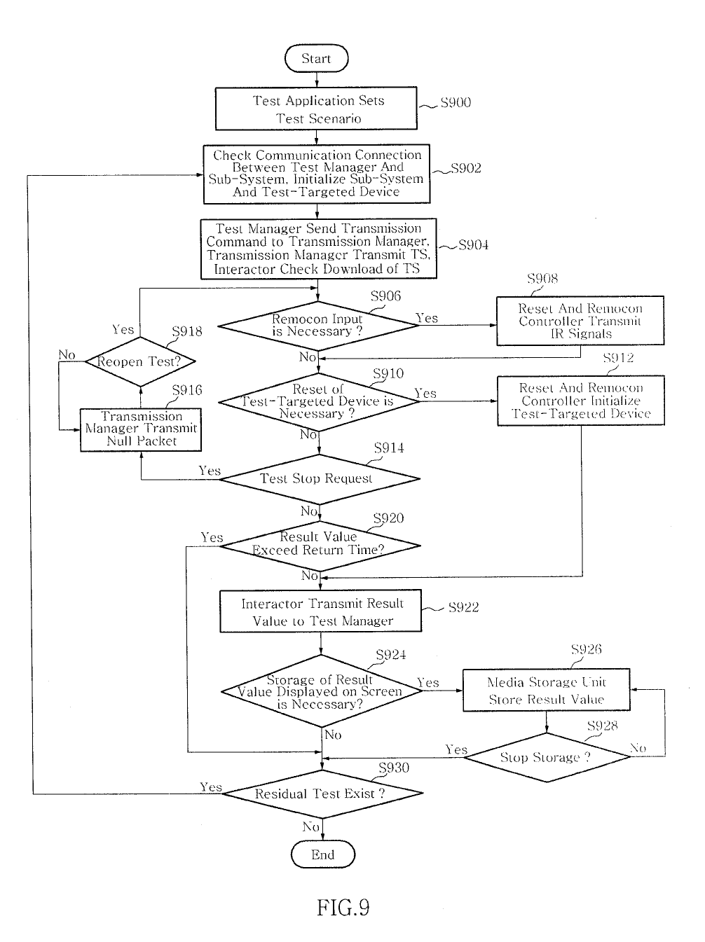

FIG. 8 is a block diagram illustrating the construction of the reset and remocon controller 226 in the automated testing device for the data broadcast receiver based on the scenario according to the present invention.

The reset and remocon controller 226 generates reset and infrared remocon key signals for controlling the power of the test-targeted device 140 during the test. The reset and remocon controller 226 includes a power and remocon control server 810 and a power and remocon controller 820.

The power and remocon control server 810 operates in host environments including a MS-windows OS, which includes a power control server 812 and a remocon control server 814.

The power control server 812 receives a reset-related request for the test-targeted device 140 from the test manager 210, and controls the power of the test-targeted device 140 by using a power controller 822 of the power and remocon controller 820, thereby performing a reset operation.

The remocon control server 814 receives a series of remocon key values, which is to be transmitted to the test-targeted device 140, from the test manager 210, generates input data to an IR signal transmitter 824 of the power and remocon controller 820, and controls the IR signal transmitter 824 to transmit IR signals to the test-targeted device 140.

The IR signal transmitter 824 stores in advance information for an IR signal sequence, which is used in the test-targeted device 140, as a predetermined file before the test, or stores key progression values of IR signals for remocon key values through a previous learning for an actual remocon, so that it is not necessary for a manager to perform separate operations during the test.

FIG. 9 is a flow diagram illustrating a method for testing a common platform of a broadcasting receiver by using the automated testing device for the data broadcast receiver based on the scenario according to the present invention.

First, the test application 110 sets a test scenario according to a test application program and a test sequence suitable for the test-targeted device 140 (S900).

After the test scenario is set, the test manager 210 checks a communication connection between the test manager 210 and a sub-system in order to ensure physical communication channels. If the communication connection is checked, the test manager 210 initializes internal hardware, internal state information, communication matching, etc., of the sub-system, and performs an initialization for the test-targeted device 140 (S902).

The transmission manager 220 forms a TS and transmits the TS to the test-targeted device 140, and then starts a return time count in order to receive test result values from a time point at which the interactor 222 has transferred downloading confirmation signals of the TS to the test manager 210 (S904).

During the test process, whether it is necessary to input remocon signals to the test-targeted device 140 or not is determined (S906).

If it is necessary to input remocon signals to the test-targeted device 140, the test manager 210 transmits remocon IR key values to the reset and remocon controller 226. The reset and remocon controller 226 transmits IR signals suitable for the test-targeted device 140 (S908).

During the test process, whether it is necessary to reset the test-targeted device 140 or not is determined (S910).

If it is necessary to reset the test-targeted device 140, a manager commands the reset of the test-targeted device 140. The reset and remocon controller 226 controls the power of the test-targeted device 140, and initializes the test-targeted device 140. The interactor 222 transmits test result values up to a time point at which the initialization is performed to the test manager 210 (S912).

During the test process, whether it is necessary to stop the test momentarily or not is determined (S914).

If it is necessary to stop the test, the manager commands the stop of the test. Then, the test manager 210 sends TS stop signals to the transmission manager 220. The transmission manager 220 having received the stop signals stops TSs and transmits NULL packet information, thereby maintaining physical connection (S916).

The stopped test is reopened when the manager separately commands a test reopening (S918).

When the test starts according to test types and the test result values are not transmitted to the test manager 210 even after return time lapses, the test manager 210 commands the transmission manager 220 to stop the TSs and terminates the test (S920).

If the test is normally terminated, the test result values are transmitted to the test manager 210 through the interactor 222, and simultaneously the termination of the test is reported (S922).

When the test result values corresponds to video displayed on a screen or audio, whether it is necessary to store the test result values or not is determined (S924).

If it is necessary to store the test result values displayed on the screen, the test manager 210 commands the media storage unit 224 to store the test result values. The media storage unit 224 stores the video or the audio in a specific directory selected in an environment setup menu (S926).

The media storage unit 224 terminates the storage of the video or the audio by a storage stop command from the manager (S928).

If the interactor 222 notifies the test manager 210 of the termination of the test, or if the media storage unit 224 completes the storage of the video or the audio, whether residual tests exist in the scenario or not is determined (S930).

If the residual tests exist in the scenario, the test manager 210 commands initialization of the sub-system. After the sub-system is initialized, the test manager 210 also initializes the test-targeted device 140 and reopens the residual tests (S902).

However, if the residual tests do not exist in the scenario, the test is terminated.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

### INDUSTRIAL APPLICABILITY

According to the present invention as described above, when a test-targeted broadcasting receiver is tested by using an automated testing device for a data broadcast receiver based on a scenario, test data are automatically transmitted to the test-targeted broadcasting receiver, storage of remocon operation and screen state is included in the scenario and is automatically processed, so that it is possible to provide unmanned automatic environments in which a tester does not need to wait. As a result, in a state in which the middleware of a complicated data broadcast receiver has been implemented, personnel expenses can be reduced and test results can be systematically derived.

1. An automated testing method for a data broadcast receiver by using a test application, various channel configuration information according to the test application, and scenario information, the method comprising the steps of:
(a) setting a test scenario according to a test application program and a test sequence which are suitable for a test-targeted device by using the test application;
(b) checking communication connection between the test manager and a sub-system for securing physical communication channels to the sub-system, initializing internal hardware, internal state information and communication matching of the sub-system when the communication connection is checked, and performing an initialization for the test-targeted device by using a test manager;
(c) a transmission manager forming a transport stream, and transmitting the transport stream to the test-targeted device in response to a command from the test manager, starting a return time count for receiving test result values from a time point at which an interactor has transferred downloading confirmation signals of the transport stream to the test manager;
(d) transmitting IR signals suitable for the test-targeted device at a reset and remocon controller, if it is necessary to input remocon signals to the test-targeted device;
(e) initializing the test-targeted device if it is necessary to reset the test-targeted device;
(f) stopping the test if it is necessary to stop a test momentarily;
(g) commanding the transmission manager to stop the transport stream and terminating the test, if the test starts according to test types and the test result values are not transmitted to the test manager even after return time lapses;
(h) transmitting the test result values to the test manager through the interactor, and reporting the termination of the test if the test is normally terminated;
(i) storing the test result values in the media storage unit if the test result values correspond to video displayed on a screen or audio;
(j) determining whether residual tests exist in the scenario if the interactor notifies the test manager of the termination of the test, or if the media storage unit completes the storage of the video or the audio; and
(k) commanding an initialization of the sub-system, initializing the test-targeted device after the sub-system is initialized, and resuming the test, if the residual tests exist in the scenario.

2. The method as claimed in claim 1, wherein, in step (b), an interface between the test manager and the sub-system is connected by using a packet communication scheme based on a universalized TCP/IP for securing physical communication channels, the sub-system is initialized by the command from the test manager, and the test-targeted device is initialized by using the reset and remocon controller.

3. The method as claimed in claim 1, wherein, in step (c), the transmission manager reads a description file of the transport stream corresponding to the test application for constituting a transport stream, transmits the formed transport stream to the test-targeted device, checks if the transport stream has been normally downloaded to the test-targeted device through the interactor, and transfers check results to the test manager.

4. The method as claimed in claim 1, wherein, in step (d), the test manager transfers key values used for generation of the IR signals to the reset and remocon controller in order to input the remocon signals, and the reset and remocon controller transmits the IR signals suitable for the test-targeted device.

5. The method as claimed in claim 4, wherein a key progression corresponding to the key values used for the generation of the IR signals is input in advance through learning before the test, or is automatically generated during the test by using information provided from a manufacturer.

6. The method as claimed in claim 1, wherein, in step (f), the test manager instructs the transmission manager to stop the transport stream by using the command from the test manager and to transmit NULL packet information in order to secure physical connection, and resumes the test by a separate command.

7. The method as claimed in claim 1, wherein, in step (i), the media storage unit stores the test result values displayed on a screen or outputted as audio in a specific directory designated by an environment setup value, and discontinues storing the test result values upon receiving a separate storage stop command.

8. An automated testing system for a data broadcast receiver based on a test application, various channel configuration information according to the test application, and scenario information, the system comprising:
a test manager for transmitting signals to a sub-system, receiving return signals from the sub-system, controlling an overall flow of a test process, and managing test results;
a transmission manager for processing application programs and channel configuration information as in actual broadcasting environment, both of which are received through the test application;
an interactor for checking download of the test application to a test-targeted device, and transferring information to the test-targeted device during a test;
a media storage unit for storing video or audio output results of test result values;
a reset and remocon controller for initializing the test-targeted device and generating remocon control signals;
a report manager for processing the test result values in a report form and outputting various reports;
a results database for storing the test result values; and
a combiner/divider for combining RF signals transmitted from a modulator and an out-of-band channel transceiver into one RF signals, and inputting the combined RF signals to the test-targeted device.

9. The system as claimed in claim 8, wherein the transmission manager includes a main control manager, a channel manager, an Object Carousel (OC) generator, a Program Specific Information/Program System Information Protocol (PSI/PSIP) generator, an Application Information Table (AIT) generator, a descriptor section manager, an Out-Of-Band-System Information (OOB-SI) generator, an extended Application Information Table (XAIT) generator, a data transmitter, a Transport Stream (TS) mux, a User Datagram Protocol (UDP)transmitter, a Quadrature Amplitude Modulation (QAM) modulator, and a DOCSIS Settop Gateway/Out-Of-Band (DSG/OOB).

10. The system as claimed in claim 9, wherein the main control manager includes a communication module for communicating with the test manager, an eXtensible Markup Language (XML) parser, a matching module for generating signals including in-band and out-of-band signals, the XML parser analyzing a transport stream description file received from the test application, thereby extracting information necessary for generating an OC, information necessary for generating a PSIP, information necessary for generating an AIT, information necessary for managing a channel, information necessary for generating an OOB-SI and an XAIT, etc.

11. The system as claimed in claim 10, wherein the XML parser extracts various channel configuration information stipulated in broadcasting standard technology in North America and Korea, including AIT information, OC information, PSI/PSIP information, and OOB-SI information, and the extracted channel configuration information including in-band information and out-of-band information.

12. The system as claimed in claim 11, wherein the in-band information includes a channel information module, a PSI/PSIP information module, a bound application information module, and an OC/ES information module.

13. The system as claimed in claim 11, wherein the out-of-band information includes an OOB-SI information module and an unbound application information module.

14. The system as claimed in claim 13, wherein the OOB-SI information module generates out-of-band channel information stipulated in technical standards in North America and Korea, and transmits the out-of-band channel information to an the OOB-SI generator, and the OOB-SI generator provides information for total service channels, EPG data, service access control information for pay channels based on the received information, and provides various types of table information according to broadcasting service profiles.

15. The system as claimed in claim 13, wherein the unbound application information module provides information for generating an XAIT recommended in the digital cable broadcasting standards in North America and Korea, includes signaling information for unbound application programs independent on a specific service, and transmits the signaling information to the XAIT generator.

16. The system as claimed in claim 9, wherein the OOB-SI generator generates program and system information necessary for transmitting an unbound application.

17. The system as claimed in claim 9, wherein the XAIT generator generates unbound application information.

18. The system as claimed in claim 8, wherein the interactor checks if the test application has been normally downloaded to the test-targeted device, and transfers information to the test-targeted device during the test, the interactor including a test manager communication module, a test-targeted device communication module, a log module, and what not.

19. The system as claimed in claim 8, wherein the interactor manages information including log and extra information, received from each test-targeted device, by means of identifiers of multiple test-targeted devices, thereby supporting the test for the test-targeted devices.

20. The system as claimed in claim 8, wherein the results database represents a database used for efficiently storing, managing and displaying test logs, which are based on a MicroSoft Structured Query Language (MS SQL), and includes four database tables, which include an interactor database, an interactor information database, an interactor results database and an interactor summary database, and tables are generated according to test names whenever the test manager starts the test.

21. The system as claimed in claim 8, wherein the report manager represents a functional module for informing a manager of the synthesized test results, which is based on material stored in the results database, in a final step of the test, and includes a database grid module, a database table manager for managing total database tables, and a report module, the database grid module displaying test logs stored in a database selected by the manger through a main screen and allowing the manager to search for the test logs, and the report module collecting test result values of a test-targeted device in a form desired by the manager, and displaying the collected test result values to the manager or storing the collected test result values in a document.

22. The system as claimed in claim 8, wherein the media storage unit performs a capture operation by a command from the interactor, and includes a capture signal receiver, a capture module, a video capture card, etc.

23. The system as claimed in claim 8, wherein the reset and remocon controller generates reset and infrared remocon key signals for controlling power of the test-targeted device, and includes a power and remocon control server, and a power and remocon controller.
